(19) United States
(12) Patent Application Publication
(10) Pub. No.: US 2016/0150038 A1
(43) Pub. Date: May 26, 2016

(54) Efficiently Discovering and Surfacing Content Attributes

(71) Applicant: MICROSOFT TECHNOLOGY LICENSING, LLC., Redmond, WA (US)

(72) Inventors: Arun Sacheti, Sammamish, WA (US); Karim Hasham, Bellevue, WA (US); Parthasarathy Govindarajen, Bothell, WA (US); Kun Wu, Redmond, WA (US); Gautam V. Vaidya, Redmond, WA (US); Anthony Tran, Bothell, WA (US); Shannon Westphal, Seattle, WA (US); Nan Wu, Kirkland, WA (US); Ahmed Muneeb, Redmond, WA (US); Jane Jiyoon Park, Seattle, WA (US)

(73) Assignee: MICROSOFT TECHNOLOGY LICENSING, LLC., Redmond, WA (US)

(21) Appl. No.: 14/572,750

(22) Filed: Dec. 16, 2014

Related U.S. Application Data
(60) Provisional application No. 62/085,053, filed on Nov. 26, 2014.

(51) Int. Cl. H04L 29/08

(52) U.S. Cl. CPC H04L 67/22; H04L 67/025; H04L 67/306

(57) ABSTRACT

Systems, computing devices, and methods for efficiently surfacing information relating to an item of content to a user are presented. A process executing on a user's computing device monitors for a user indication to obtain related information regarding an item of content. Upon receiving the indication, the process formulates a request for the related information and submits the request to a content aggregation service. The content aggregation service identifies the content and extracts a plurality of attribute/value pairs from an aggregated content store regarding the subject matter of the item of content. The extracted information is returned to the requesting process as the related information, which is then presented to the user.

### BACKGROUND

As people view more and more online content, especially non-textual content (which includes images, video, audio, and the like), they are ever curious regarding that content and often would like to know more. For example, as a person (a computer user) views content of an associate's online blog, the computer user may encounter an image of which he/she may wish to know more. Indeed, even when the image is captioned and/or the surrounding content describes aspects of the subject matter of the image, the view/computer user may still have questions that are not answered, at least not answered without taking specific actions to find the information.

### SUMMARY

The following Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

According to aspects of the disclosed subject matter, systems, computing devices, and methods for efficiently surfacing information relating to an item of content to a user are presented. A process executing on a user's computing device monitors for a user indication to obtain related information regarding an item of content. Upon receiving the indication, the process formulates a request for the related information and submits the request to a content aggregation service. The content aggregation service identifies the content and extracts a plurality of attribute/value pairs from an aggregated content store regarding the subject matter of the item of content. The extracted information is returned to the requesting process as the related information, which is then presented to the user.

According to additional aspects of the disclosed subject matter, a user computing device configured to provide efficient access to content attributes is presented. The computing device includes a processor and a memory, where the processor executes instructions stored in the memory as part of, or in conjunction with, additional components of the computing device in order to provide efficient access to content attributes. These additional components include a content identification component that executes as a process on the computing device. The content identification component monitors for an indication to obtain related information regarding an item of content and, upon receiving the indication formulates a request for additional information regarding the item of content. The request is then submitted to a content aggregation service and, in response, the process obtains related information regarding the item of content from the content aggregation service. According to various embodiments, the related information includes a plurality of attribute/value pairs regarding the item of content. This related information is then presented on the computing device to the user.

According to still further aspects of the disclosed subject matter, a content aggregation service, implemented on a computing device comprising a processor and a memory, which provides information relating to an item of content is presented. The content aggregation service includes an information request API that communicates over a network communication component to receive a request for additional information regarding an item of content from a user computer. Upon receipt of a request for additional information regarding an item of content, an information identification component is executed that identifies the subject matter of the item of content in the received request according to information of content items stored in an aggregated content store. Moreover, the information identification component extracts related information to the item of content from the aggregated content store. The extracted related information comprises a plurality of attribute/value pairs from the aggregated content store of the identified subject matter. Thereafter, the related information is returned to the request computer device.

According to still further aspects of the disclosed subject matter, a computer-implemented method for efficiently obtaining and surfacing information relating to an unknown item of content is presented. In execution, the method monitors for an indication to obtain related information regarding an item of content presented to a user upon a computing device. Upon receiving the indication, a request is automatically formulates for obtaining additional information regarding the item of content and submitted to a content aggregation service. In response, related information regarding the item of content is obtained from the content aggregation service. According to various embodiments, the related information comprising a plurality of attribute/value pairs regarding the item of content. The related information is presented via the computing device to the user. Further, the steps of this method regarding monitoring, receiving, formulating, submitting, obtaining and presenting are conducted without changing the execution context on the computing device.

### BRIEF DESCRIPTION OF THE DRAWINGS

The foregoing aspects and many of the attendant advantages of the disclosed subject matter will become more readily appreciated as they are better understood by reference to the following description when taken in conjunction with the following drawings, wherein:

FIG. 1 is a pictorial diagrams illustrating exemplary network environment suitable for implementing aspects of the disclosed subject matter;

FIG. 2 illustrates an exemplary exchange between a user computing device and the content aggregation service in obtaining information relating to displayed content on the user's computing device;

FIG. 3 is a block diagram illustrating exemplary components of a suitably configured content aggregation service;

FIG. 4 is a flow diagram illustrating an exemplary routine, as implemented by a suitably configured content aggregation service, for processing a content item, such as content item identified by a crawling process and/or a content item identified in a content information request;

FIG. 5 is a flow diagram illustrating an exemplary routine, as implemented by a content aggregation service, for responding to an information request regarding a content item;

FIG. 6 is a flow diagram illustrating an exemplary routine for obtaining additional information regarding an item of content;

FIGS. 7A-7C are pictorial diagrams illustrating an exemplary user interaction for obtaining additional information regarding an item of content; and

FIG. 8 is a block diagram illustrating exemplary components of a computing device suitable for implementing aspects of the disclosed subject matter, particularly in regard to a process executing on a computing device for identifying content.

### DETAILED DESCRIPTION

For purposes of clarity, the term “exemplary” in this document should be interpreted as serving as an illustration or example of something, and it should not be interpreted as an ideal and/or a leading illustration of that thing.

The term “content” refers to items and/or data that can be presented, stored, arranged, and/or acted upon. Often, but not exclusively, content corresponds to data/items that can be presented to a computer user via a computing device. Examples of content include, by way of illustration and not limitation, textual files, images, audio, video, document/book data files, Web pages, user posts, data streams, and the like, as well as portions thereof. Content may be persisted/stored in one or more formats. Additionally, persisting content may comprise storing the content itself in a data store and/or storing a reference to the content in the data store. A particular division of content is “non-textual content.” Non-textual content corresponds to content that is not textual data, not a text-based format. By way of non-limiting examples, images, videos, audio files, haptic files, presentation files, and the like are all examples of non-textual content. Non-textual content may include representations of textual content, such as an image of sign or billboard with a textual message, but the format of the content is not a text-based format. As yet another example, a PDF (a portable document format) file is an example of non-textual content that, as is well known, may include representations of textual content, and further may include a textual transcription of the textual content of the file.

Regarding the terms “application” and “app,” generally speaking an “application” or “software application” refers to a body of software code/instructions designed to carry out one or more operations by way of execution by a processor on a computing device. Similarly, an “app” is also body of software code/instructions designed to carry out one or more operations by way of execution by a processor on a computing device. Typically, but not exclusively, an “app” is typically narrowly focused on performing a small set of operations, often inter-related with regard to a general task, whereas an “application” will have a larger focus and scope with regard to its purpose. While the terms app and application may be mentioned separately in this document, the differences between an app and an application, with respect to the disclosed subject matter, are almost meaningless. Accordingly, while the terms app and application may be mentioned separately in the disclosure document (as they do have some differences), for purposes of the capturing content to a content store (as disclosed in this document) they should be viewed as synonymous.

Typically, when a computer user wishes to know more regarding content, and particularly in regard to non-textual content, the computer user must proactively take numerous steps to obtain the desired information. These steps include (by way of illustration and not limitation): changing the execution context on the user's computing device to one (another app, application, or web page) in which the computer user can submit a query regarding the content. Of course, this context switch may further involve saving a copy of the content to a local data store, forming and submitting one or more specific queries with regard to content in order to obtain the information that is sought. Of course, the resulting information is presented in a series of search results pages—likely in a different execution context from that in which the computer user began the process, saving any specific search results as needed, and finally switching back to the original execution context from which this process started. In contrast to this cumbersome and inefficient process and according to aspects of the disclosed subject matter, information regarding content (such as non-textual content) is provided to the computer user within the current execution context, i.e., without requiring the computer user to switch the execution context. Further, the computer user does not need to one or more search queries (though is not prevented from doing so) in order to locate information regarding the content, and robust and diverse information regarding the content is provided to the computer user in the current execution context. Advantageously, according to aspects of the disclosed subject matter the computer user does not need to capture and temporarily store the content (i.e., the subject matter of which additional information is sought.) Additionally, elements of the disclosed subject matter may operate in a manner to anticipatorily obtain additional information regarding currently viewed/presented information, thereby reducing the latency of obtaining such additional information. Further still, according to aspects of the disclosed subject matter, the current execution context, user preferences and patterns may be used to identify and prioritize related information regarding the content. These and other aspects of the disclosed subject matter are set forth below. Yet a further advantage of the disclosed subject matter is that the content for which a computer user seeks additional, related information may be entirely unidentified or unknown content to the computer user.

According to aspects of the disclosed subject matter, a content aggregation service is provided. The content aggregation service maintains an aggregated content store of aggregated information regarding content that is available on a network, such as the Internet or the World Wide Web. The content aggregation service maintains an aggregated content store of that content available on the network. Typically, though not exclusively, content data and/or information in the aggregated content store is indexed according to a number of index keys to facilitate quick access and retrieval of information. As will be discussed in greater detail below, at least some of the index keys correspond to attributes and/or aspects of content items stored in the aggregated content store. In addition to maintaining the aggregated content store, the content aggregation service further provides an interface, an information request API (application programming interface), which a process executing on the computer user's computing device can access in order to obtain information related to a particular content item. While, according to various configurations, the content aggregation service may be implemented on the computer users computing device, typically the content aggregation service is implemented as an independent service (i.e., independent of a computer users computing device) accessible to one or more computer users over a network.

As indicated above, a process or service executing on the computer user's computing device is configured to interact with the content aggregation service to obtain additional information regarding one or more items of content that is presented/displayed to the computer user on the computing device. According to various embodiments, this process, upon detecting a user indication to obtain more information regarding a particular item of content, communicates with the content aggregation service via the information request API on behalf of the computer user. All or some of the information obtained from the information request API is then displayed to the computer user. In addition to acting upon a user indication to obtain more information, in various embodiments the process/server executing on the computer users computing device may anticipatorily obtain information related to one or more items of content, including non-textual content, for display to the computer user.

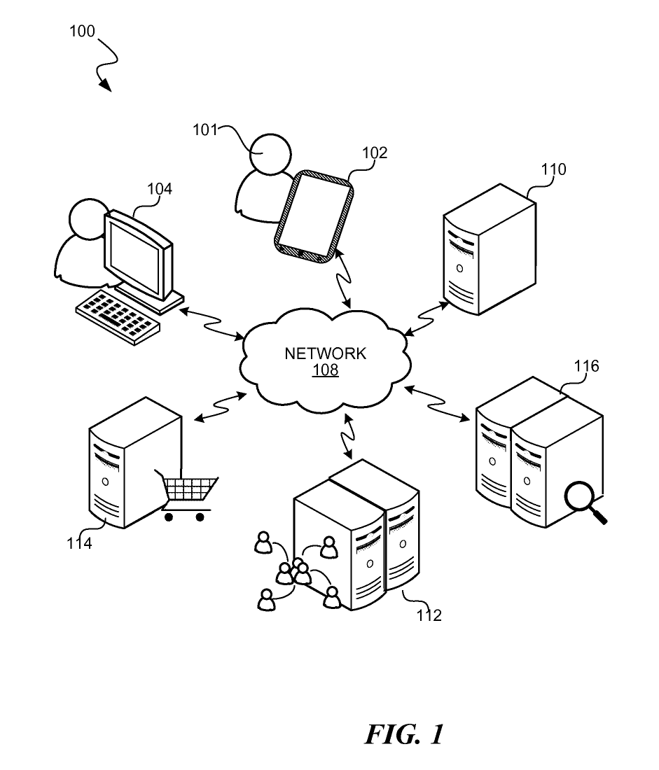

With this general description of the disclosed subject matter in mind, reference is now made to the figures. FIG. 1 is a pictorial diagram illustrating an exemplary network environment 100 suitable for implementing aspects of the disclosed subject matter, particularly in regard to providing information regarding non-textual content. As shown in FIG. 1, the network environment 100 includes various web sites/services connected over one or more networks, such as network 108, which host content. By way of illustration and not limitation, these websites/services may include: one or more social networking sites, such as social networking site 112; one or more network shopping sites such as network shopping site 114; one or more user online service providers such as search engine 116; one or more news related network sites (not shown); one or more user blog sites/services (not shown); and the like. Further still, the network environment 100 further includes one or more user computing devices, such as user computing devices 102 and 104, by which a computer user, such as computer user 101, can obtain additional information related to a particular item of content according to aspects of the disclosed subject matter.

Of course, also included in the network environment 100 is a content aggregation service 110 that response to information requests for information relating to one or more content items for presentation on a computing device (such as computing device 102) to a computer user, such as computer user 101. According to aspects of the disclosed subject matter, the content aggregation service 110 obtains information regarding content available throughout the network 108. The content aggregation service 110 may obtain the information relating to the available content according to a variety of sources which include, by way of illustration and not limitation: one or more processes that crawl the network sites on the network 108; obtaining information from various user-centric sites including social networking sites such as social networking site 112; obtaining search query logs from one or more search services, such as search engine 116; obtaining browsing history of one or more computing devices, such as computing devices 102 and 104; and the like. The content aggregation service 110 may further obtain the information relating to content from contextual understanding of an item of content (including the format type of the content, objects within the content, and the like); from apps/applications that consume, create, and/or edit content; as well as from contextual understanding of a computer user's interaction and/or use of the content that may be provided in a user request—as discussed below. According to aspects of the disclosed subject matter, as content is encountered through these various “obtaining” processes, the content is identified and aggregated in the aggregated content store of the content aggregation service 110. Further still, attributes and aspects relating to the identified, aggregated content are also identified, and the aggregated information regarding the content, such as the location of the encountered content, the identified attributes of the content, and the like, are stored in the aggregated content store for use in responding to content information requests.

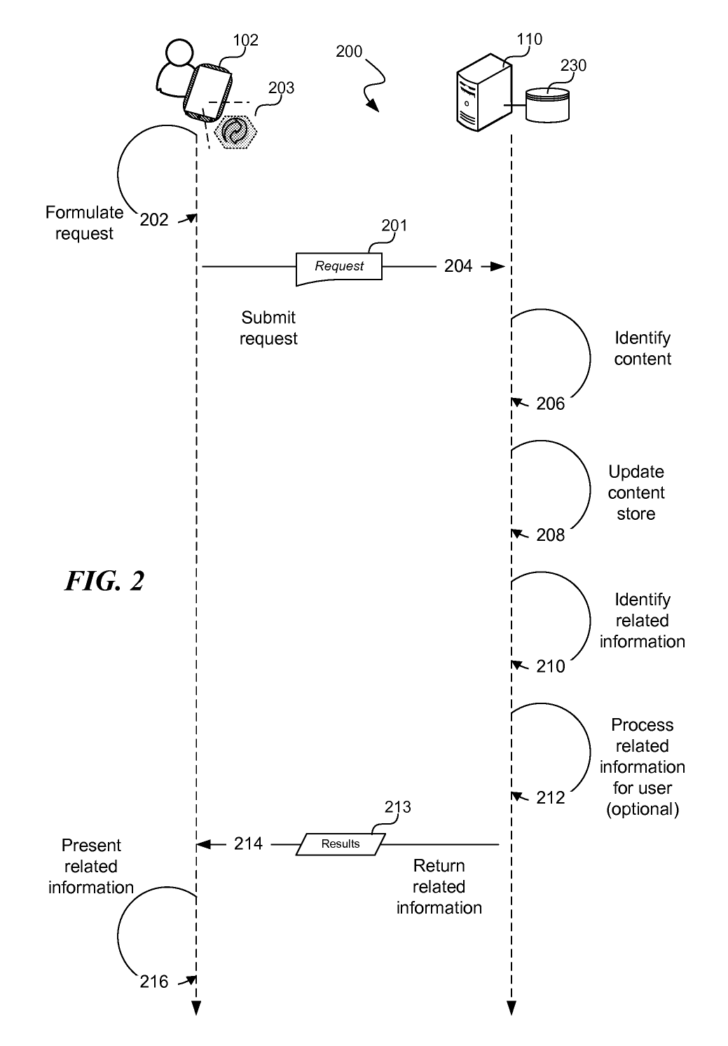

FIG. 2 illustrates an exemplary exchange 200 between a user computing device 102 and a content aggregation service 110 in obtaining information relating to displayed content on the user's computing device. As indicated by arrow 202, a request 201 is generated/formulated by a process 203 executing on the computing device 102 to request additional information related to the content presented to a computer user. According to aspects of the disclosed subject matter, the request 201 (as generated by the process) includes information that identifies or includes the content for which the information is requested. In various embodiments, a universal resource locator (URL) or universal resource identifier (URI) is supplied as the identity of the content. Alternatively or additionally, a copy or portion of the content may be included in the request 201 as a way of identifying the content to the content aggregation service 110. In yet alternative embodiments, a “signature” of the content may be provided which is generated from the content, or a portion thereof, according to a predetermined algorithm such as a hash algorithm, a compression algorithm, and the like.

In addition to information that identifies the content to the content aggregation service 110, contextual information may also be included in the request 201. The contextual information may include, by way of illustration and not limitation: the application that is currently displaying the content; the content type (e.g., an audio file, a video file, an image, a presentation file, a PDF file, etc.); a particular location in the content (e.g., chapter/title, current position, page number, scene, etc.); and the like. Of course, the contextual information as well as identifying information may be content-type dependent, i.e., the specific information provided may be a function of the content type for which the additional information is sought.

Related information may also be included in the request 201. The related information may include, as illustration and not limitation: captions associated with the content and/or descriptions related to the content (both of which may be found in the same web page/post/blog/etc.) The related information may also include user comments and/or posts regarding the content.

Other information in the request 201 may further include computer user preferences (both explicitly defined as well as implicitly determined) and behaviors. These may be used in identifying priorities in surfacing information and information pivots regarding the content for which the information is sought. In sum, the request 201 includes information that the content aggregation service 110 can use to identify the content and, to the extent possible, identify what information regarding the content is sought. The latter—identifying what information regarding the content is sought—may be especially useful when the computer user would like to know information regarding who the actors are in a particular scene in a video, or who is the soloist of an audio file.

Once the request 201 is generated or formulated, it is submitted to the content aggregation service 110, as indicated by arrow 204.

Upon receiving the request 201, the content aggregation service 110 first identifies the content for which the request was made, as indicated by arrow 206. The content is identified according to the information provided in the request 201. Depending on the particular information supplied, the content aggregation service 110 may obtain a copy of the content (according to a URL/URI that is supplied). Based on the information that is supplied, the content aggregation service 110 determines whether an entry for the content already exists within an aggregated content store 230 that the content aggregation service 110 maintains. As will be discussed in greater detail below, entries for content in the aggregated content store 230 includes information corresponding to a plurality of attributes and aspects of the content, referred to hereafter as content attributes. Each content attribute is associated with one or more values (depending on the nature of the content attribute) that describes the corresponding content. Examples of content attributes include, by way of illustration and not limitation: the best summary (or summaries) of the corresponding content; the best caption (or captions) of the corresponding content; the distribution of the content in the Internet; a location (or locations) of the highest quality version of the content; locations of similar content; user-comment threads regarding the content; originator of the content; the subject matter of the content; locations where the content is most viewed/played/accessed; queries most likely to locate the content; typical user intent in searching for the content; shopping locations offering the subject matter of the content; applications/apps that enable a computer user to interact with the content—including those apps/applications that are considered the best apps and/or applications for the task; and the like. Clearly, each item of content in the aggregated content store 230 may include numerous content attributes. Moreover, as will be described in greater detail below, each content attribute may comprise an information pivot, i.e., a data point regarding the content in which the content and other items of content can be viewed and explored.

Returning to FIG. 2, after identifying the content within the aggregated content store 230, or determining that the content is a new item not already in the aggregated content store, the content aggregation service 110 determines the values of the content attributes of the content and updates the information in the aggregated content store (if the content is already represented by a content item in the aggregated content store) or adds a content item to the aggregated content store along with the corresponding content attributes/values pairs (if the content is not already represented by a content item in the aggregated content store), as indicated by arrow 208. Of course, updating (or adding) the aggregated content store 230 may involve determining whether a caption associated with the content for which information is sought might be the best caption, determining whether the content is the highest quality content, whether the URL of the content is already included among the locations of the distribution of the content, and the like.

After updating the aggregated content store 230, the content aggregation service 110 identifies related information of the content, i.e., accesses the content attribute/value pairs, as indicated by arrow 210. The content attribute/value pairs may (optionally) then be processed to prioritize the information that is returned. According to various embodiments, the information may be prioritized and/or processed according to the requesting computer user's preferences and context, as indicated by arrow 212. As indicated by arrow 214, the results 213 (i.e., the related information) are returned to the computer user (or more particularly, to the process 203 executing on the computer user's computing device 102) where the related information is presented to the computer user, as indicated by arrow 216.

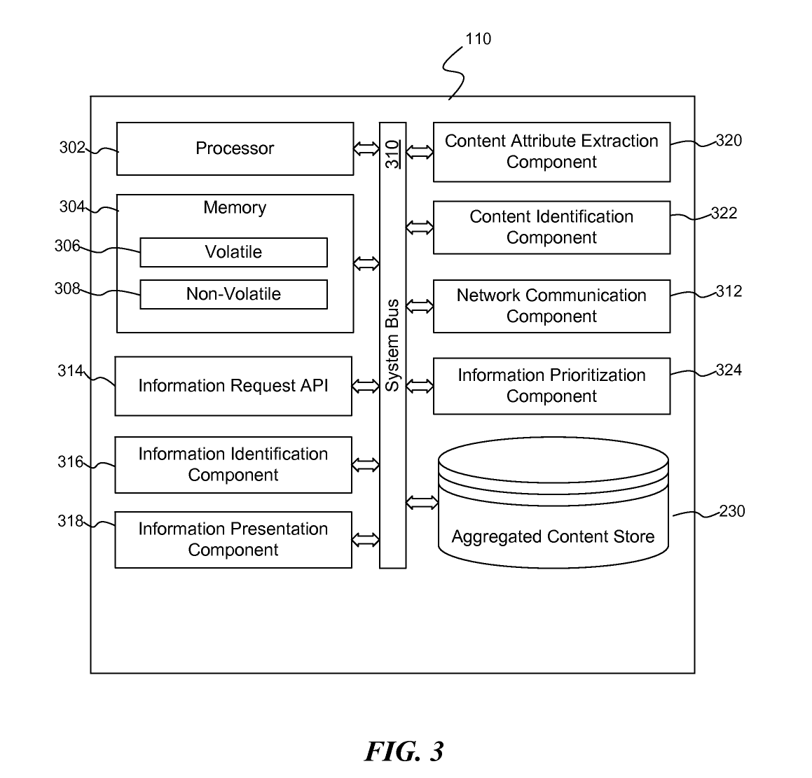

With regard to the content aggregation service 110, the content aggregation service may be implemented as service hosted on one or more computing devices and configured to respond to an information request regarding content from one or more user computing devices. When configured on multiple computing devices, each computing device may be configured with all components of a content aggregation service (as will be described below), or with various components located on different computing devices. However, for simplicity, a content aggregation service will be described in regard to its implementation on a single computing device. FIG. 3 is a block diagram illustrating exemplary components of a suitably configured content aggregation service 110. The content aggregation service 110, as implemented on a single computing device, includes at least one processor 302 (or processing unit) and a memory 304, interconnected by way of a system bus 310. As will be readily appreciated, the memory 304 typically (but not always) comprises both volatile memory 306 and non-volatile memory 308. Volatile memory 306 retains or stores information so long as the memory is supplied with power. In contrast, non-volatile memory 308 is capable of storing (or persisting) information even when a power supply is not available. Generally speaking, RAM and CPU cache memory are examples of volatile memory 306 whereas ROM, solid-state memory devices, memory storage devices, and/or memory cards are examples of non-volatile memory 308.

The processor 302 executes instructions retrieved from the memory 304 in carrying out various functions, particularly in regard to responding to information requests (such as information request 201 of FIG. 2) regarding content. The processor 302 may be comprised of any of various commercially available processors such as single-processor, multi-processor, single-core units, and multi-core units. The system bus 310 provides an interface for the various components of the mobile device to inter-communicate. The system bus 310 can be of any of several types of bus structures that can interconnect the various components (including both internal and external components). The exemplary computing system 110 configured as a content aggregation system further includes a network communication component 312 for interconnecting the computing device/content aggregation service 110 with other network accessible computers, online services, and/or network entities as well as other devices on a computer network, such as network 108. The network communication component 312 may be configured to communicate with the various computers and devices over a network 108, such as user computing devices 102 and 104 as well as computing devices and services 112-116. This communication may be conducted by the network communication component 312 via a wired connection, a wireless connection, or both. As will be readily appreciated by those skilled in the art, a network communication component, such as network communication component 312, is typically comprised of hardware and/or firmware components (and may also include or comprise software components) that transmit and receive digital and/or analog signals over a transmission medium (i.e., the network 108.)

Also included in the content aggregation service 110 is an information request API 314. The information request API 314 is an executable component that implements a service for receiving and responding to information requests, such as information request 201 of FIG. 2. Generally speaking, the information request API 314 is the portal by which a service on a computer user's computing device obtains additional information relating to an item of content, including content that is not already know to the computer user. The information request API 314 interacts with other components (as described below) in processing an information request from a computer user regarding content. As discussed with regard to arrow 206 of FIG. 2, a content identification component 322 identifies the content item (the subject matter of the information request 201), either as a content item that is already known to the content aggregation service 110 or as a new content item.

Once the content item is identified, either as an existing content item to the content aggregation service 110 or as a new content item, a content attribute extraction component 320 extracts attribute and/or aspect pairs of the identified content item. In this instance, extraction implies identifying attributes and/or aspects of the identified content item and determining one or more values corresponding to the identified attributes. This extraction involves several processes including analysis of the content which are largely specific according to the type of identified content, but may include a process for identifying the content type, the subject matter of the content, subject matter quality, contextual usage, and the like. Information such as content resolution, channels, title/chapter/page, caption, description, URL/URI, related items, and the like (many of which were previously discussed) are identified through these processes and associated with the identified content. To the extent that the identified content is a known content item to the content aggregation service 110, the attribute data regarding this item may be updated as appropriate in an aggregated content store 230. Alternatively, to the extent that the identified content is new to the content aggregation service 110, the content item and attribute pairs are added to the aggregated content store 230.

Additional attribute information that may be associated with an identified item of content may include, by way of illustration and not limitation: one or more apps and/or applications suitable for editing, consuming, or creating the content item; content-usage intent based on the contextual usage of the content item (e.g., shopping, advertising, travel, fan appreciation, social interaction, etc.); and the like.

After ensuring that the content item is identified to the content aggregation service 110 and at the direction of the information request API 314, an information identification component 316 identifies and extracts the requested additional information regarding the requested content item from the aggregated content store. This additional information corresponds to the attribute/aspect—value pairs that are associated with the content item. Optionally, an information prioritization component 324 can order and prioritize the extracted information regarding the requested content. This ordering/prioritization may be conducted according to the context of the information request 201, preferences and/or priorities of the computer user which has (either directly or indirectly) requested the additional information, general user preferences regarding the content, and the like. Further still, an information presentation component 318 may process the extracted information for presentation to the computer user on the computing device 102.

After the requested information regarding the content item is obtained (and optionally prioritized and/or ordered, as well as optionally organized for presentation to the computer user on the computing device 102), the resulting information (results 213) is returned to the requesting computing device for presentation to the computer user.

Regarding various components of the content aggregation service 110, and in particular in regard to the content attribute extraction component 320, the content identification component 322, the information prioritization component 324, the information presentation component 318, and the information identification component 316, typically but not exclusively these components are implemented as executable services in the content aggregation service. Alternatively, any or all of these components may be implemented as hardware and/or firmware components in the content aggregation service 110.

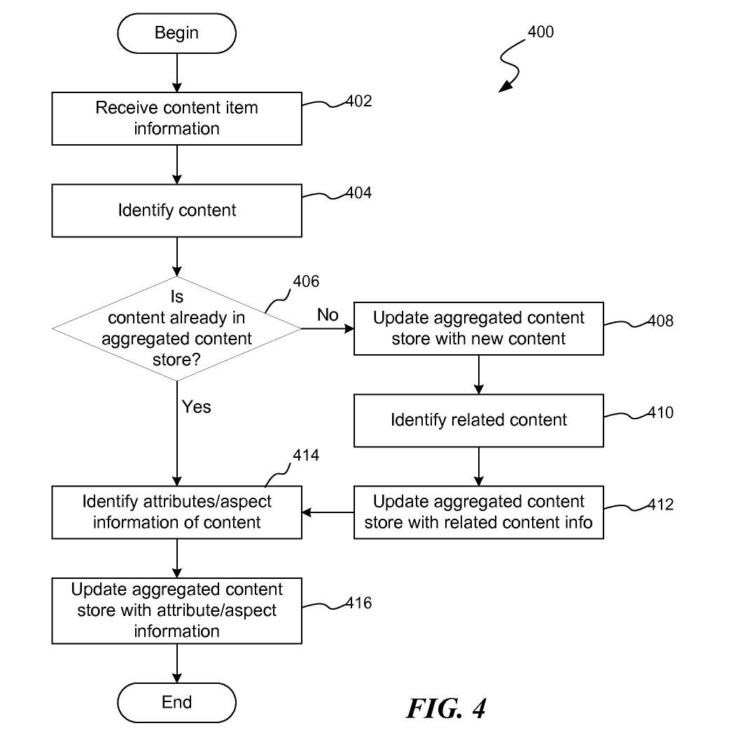

Turning to FIG. 4, FIG. 4 is a flow diagram illustrating an exemplary routine 400, as implemented by a suitably configured content aggregation service 110, for processing content, such as content received from a crawling process and/or content identified in a content information request, such as request 201. Beginning at block 402, the content aggregation service 110 receives information of an item of content (e.g., the URL of the content item). At block 404 the content aggregation service 110 identifies the content, i.e., determines an identity for the content. At decision block 406, a determination is made as to whether the content item is already known to the content aggregation service, i.e., is it already in the aggregated content store 230 or is it new to the content aggregation service.

If the content is not already in/known aggregated content store (i.e., is new), at block 408 the aggregated content store is updated with the new content. At block 410, content items that may be related to the received content item are also identified and those connections are made in the aggregated content store 230. At block 412, the aggregated content store is updated with the related content information.

If the content is already in the aggregated content store 230, or after identifying the received content and related content information, attribute and aspect information regarding the received content is identified. These attributes, including those discussed above, are associated with one or more values and, at block 416, the information regarding the received content is updated as appropriate, including adding the attribute/value pairs for newly identified content. Thereafter, the routine 400 terminates. While not shown in FIG. 4, in some instances the identity of the received content is returned as a function of executing this routine.

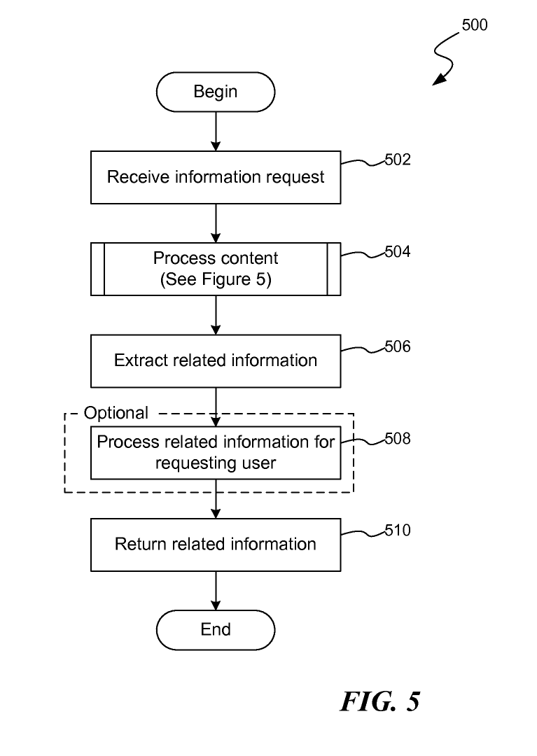

FIG. 5 is a flow diagram illustrating an exemplary routine 500, as implemented by a content aggregation service 110, for responding to an information request regarding a content item. Beginning at block 502, the content aggregation service 110 receives a content request via the information request API 314 of FIG. 3. As discussed above, this request 201 includes information describing the content for which additional information is requested, contextual information, user preferences, and the like. At block 504, a routine to process and identify the content, such as routine 400 of FIG. 4, is called.

At block 506, based on the identity of the received content as determined in block 504, information related to the identified content is extracted from the aggregated content stored 230. Optionally, at block 508, the extracted information (i.e., related information) is processed for the requesting user. As mentioned previously, this information may be prioritized, ordered, and/or formatted for presentation to the requesting computer user. Thereafter, at block 510, the related information to the content item of the information request is returned to the requesting computer user, and the routine 500 terminates.

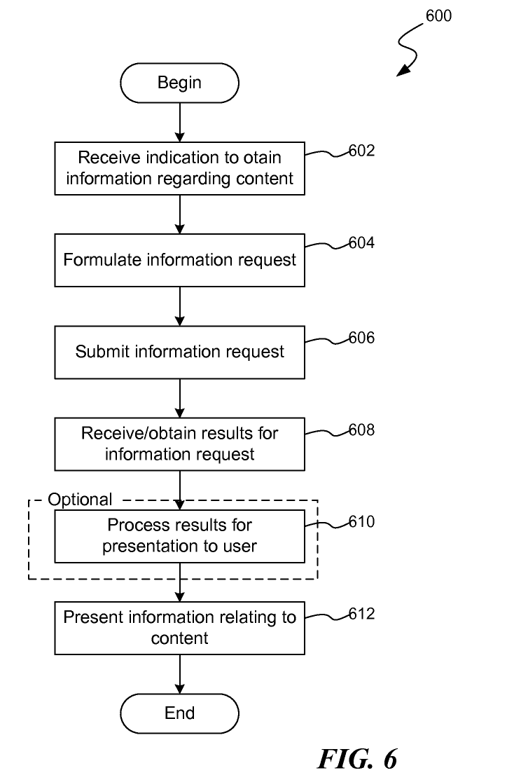

In contrast to the processing and routines that occur on the content aggregation service 110, FIG. 6 is a flow diagram illustrating an exemplary routine 600 for obtaining additional information regarding an item of content. Beginning at block 602, a process executing on the computer user's computing device (such as computing device 102 or 104) receives an indication that additional information regarding an item of content is desired. This indication may be an express indication made by the computer user of the computing device or, alternatively, may be anticipatorily made on behalf of the computer user to obtain information regarding an item of content. For example, if an item of content is viewed by the computer user which is not associated with a caption or descriptive information, the process may anticipatorily request the additional information for the user.

At block 604, an information request is generated. As indicated above, the information request includes information that identifies or includes the content for which the additional information is requested. In various embodiments, a universal resource locator (URL) or universal resource identifier (URI) is supplied as the identity of the counted. Alternatively or additionally, a copy or portion of the content may be included in the request as a way of identifying the content to the content aggregation service. In yet alternative embodiments, a “signature” of the content may be provided which is generated from the content, or a portion thereof, according to a predetermined algorithm such as a hash algorithm, a compression algorithm, and the like.

As mentioned above, in addition to information that identifies the content item to the content aggregation service 110, contextual information may also be included in the request. The contextual information may include, by way of illustration and not limitation: the application that is currently displaying the content; the content type (e.g., an audio file, a video file, an image, a presentation file, a PDF file, etc.); a particular location in the content (e.g., chapter/title, current position, page number, scene, etc.); and the like. Of course, the contextual information as well as identifying information may be content-type dependent, i.e., the specific information provided may be a function of the content type for which the additional information is sought.

Related information may also be included in the request to the content aggregation service 110. This related information may include, as illustration and not limitation: captions associated with the content and/or descriptions related to the content (both of which may be found in the same web page/post/blog/etc.) The related information may also include user comments and/or posts regarding the content.

Also, other information in the request may further include computer user preferences (both explicitly defined as well as implicitly determined) and behaviors. These may be used in identifying priorities in surfacing information and information pivots regarding the content for which the information is sought. In sum, the request includes information that the content aggregation service 110 can use to identify the content and, to the extent possible, identify what information regarding the content is sought.

At block 606, the information request is submitted to the content aggregation service 110, as described. In response, at block 608, the exemplary routine receives the results of the information request, i.e., additional related information regarding the item of content. As previously mentioned, the returned results may have been processed by the content aggregation service 110 according to user preferences, the current context, as well as for presentation on the requesting computer user's computing device. Alternatively and optionally, at block 610, the results from the content aggregation service 110 may be processed on the computer user's computing device to prioritize the results such that those items deemed most important to the content and the user are displayed before those that are not, as well as in regard to the display or presentation capabilities of the computing device. Thereafter, at block 612 the information is presented to the computer user, and the routine 600 terminates.

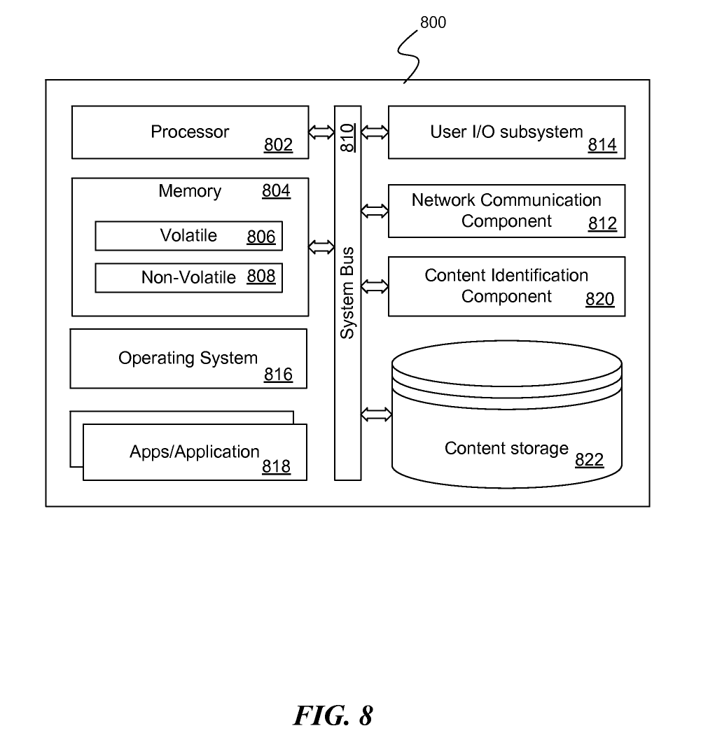

Regarding routines 400, 500 and 600 described above, as well as other processes describe herein, while these routines/processes are expressed in regard to discrete steps, these steps should be viewed as being logical in nature and may or may not correspond to any actual and/or discrete steps of a particular implementation. Also, the order in which these steps are presented in the various routines and processes should not be construed as the only order in which the steps may be carried out. In some instances, some of these steps may be omitted. Moreover, while these routines include various novel features of the disclosed subject matter, other steps (not listed) may also be carried out in the execution of the subject matter set forth in these routines. Those skilled in the art will appreciate that the logical steps of these routines may be combined together or be comprised of multiple steps. Steps of the above-described routines may be carried out in parallel or in series. Often, but not exclusively, the functionality of the various routines is embodied in software (e.g., applications, system services, libraries, and the like) that is executed on one or more processors of computing devices, such as the computing device described in regard to the content aggregation service 110, and in regard to the user computing device described below in regard to FIG. 8. As previously mentioned, in various embodiments all or some of the various routines may also be embodied in executable hardware modules including, but not limited to, system on chips, specially designed processors and or logic circuits, and the like on a computer system.

These routines/processes are typically implemented in executable code comprising routines, functions, looping structures, selectors such as if-then and if-then-else statements, assignments, arithmetic computations, and the like. However, the exact implementation in executable statement of each of the routines is based on various implementation configurations and decisions, including programming languages, compilers, target processors, operating environments, and the linking or binding operation. Those skilled in the art will readily appreciate that the logical steps identified in these routines may be implemented in any number of ways and, thus, the logical descriptions set forth above are sufficiently enabling to achieve similar results.

While many novel aspects of the disclosed subject matter are expressed in routines embodied in applications (also referred to as computer programs), apps (small, generally single or narrow purposed, applications), and/or methods, these aspects may also be embodied as computer-executable instructions stored by computer-readable media, also referred to as computer-readable storage media. As those skilled in the art will recognize, computer-readable media can host computer-executable instructions for later retrieval and execution. When the computer-executable instructions that are stored on the computer-readable storage devices are executed, the execution thereof causes, configures and/or adapts the computing device to carry out various steps, methods and/or functionality, including those steps, methods, and routines described above in regard to the various illustrated routines. Examples of computer-readable media include, but are not limited to: optical storage media such as Blu-ray discs, digital video discs (DVDs), compact discs (CDs), optical disc cartridges, and the like; magnetic storage media including hard disk drives, floppy disks, magnetic tape, and the like; memory storage devices such as random access memory (RAM), read-only memory (ROM), memory cards, thumb drives, and the like; cloud storage (i.e., an online storage service); and the like. For purposes of this disclosure, however, computer-readable media expressly excludes carrier waves and propagated signals.

As indicated above, a computer user may explicitly provide instruction to obtain additional information regarding an item of content. According to various embodiments of the disclosed subject matter, advantageously a user can obtain additional information without the need to change the current execution context and/or manually formulate a search query regarding that content. Instead, a process that executes on the computer user's computing device may be invoked. This process may be implemented as an operating-system level service. Advantageously, an operating system-level process or service can be accessed from within an execution context, and the invoked operating system-level process functions without changing the execution context. In other words, a process to access additional information regarding an item of content, being an operating system-level service, can be used from within an executing application without changing the execution context (i.e., switching to another application). Of course, it should be appreciated that the disclosed operating system-level process need not be implemented as a function of the operating system of a computing device, but rather that the process may be invoked in the same manner from all execution contexts and the process function as an extension of the current execution context, so that the execution context is not changed.

In alternative embodiments, the functionality for obtaining additional information regarding an item of content may be implemented in an execution library that may be linked within any number of computer applications. For example, a network browser (or any number of apps and/or applications) may include a library or execution module that provides the functionality to obtain additional information regarding an item of content.

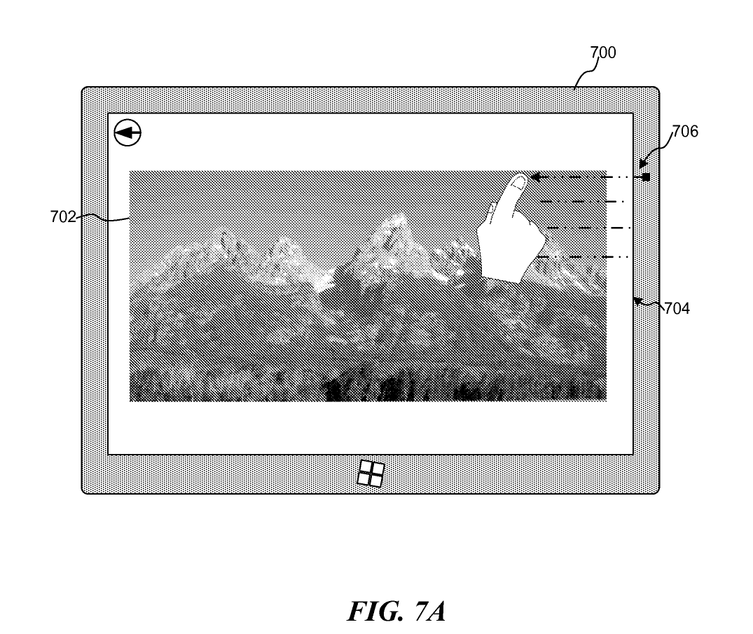

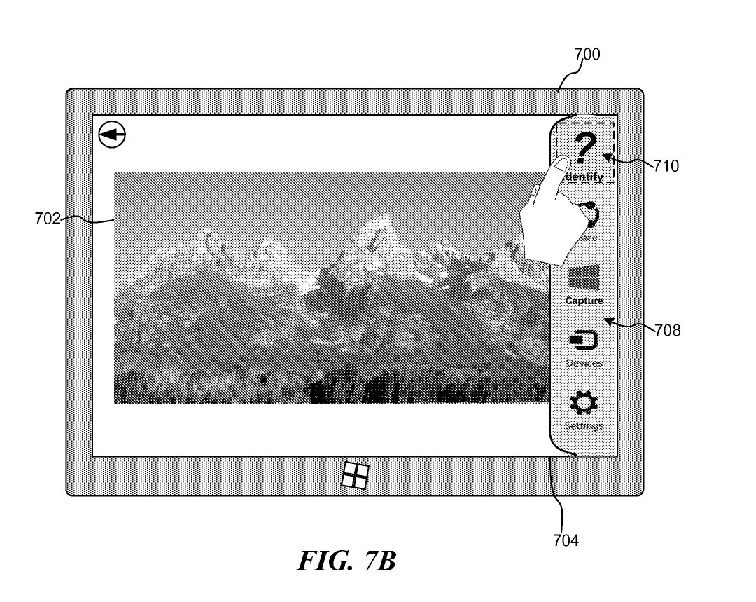

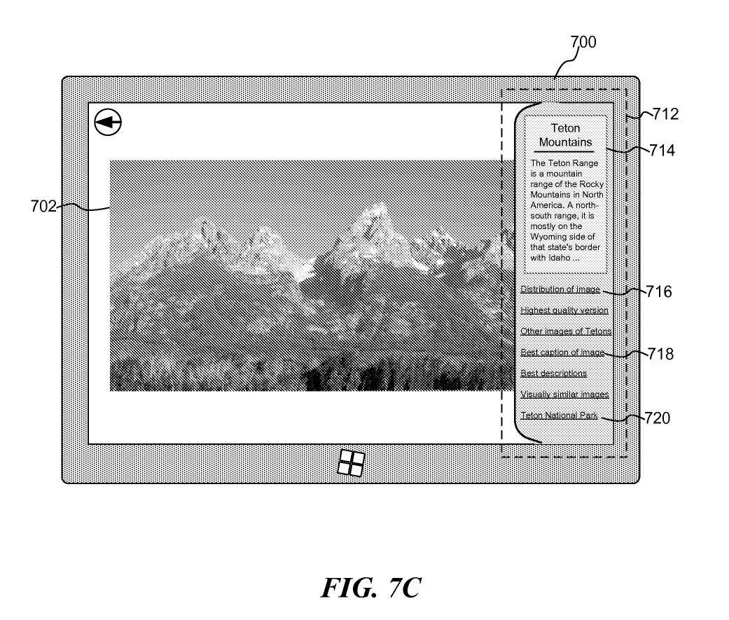

In regard to a user interaction to obtain additional information regarding an item of content, FIGS. 7A-7C are pictorial diagrams illustrating an exemplary user interaction for accessing the additional information of an item of content. As can be seen, FIG. 7A includes a computing device 700 displaying an image 702 (a non-textual item of content) on a display surface 704. For this example and assuming that the computer user wishes to identify the particular image 702, the computer user can interact with the process to obtain additional information by swiping from the right edge of the display surface 704, as indicated by arrow 706.

In FIG. 7B, after having swiped from the right edge of the display surface 704, a window 708 of interactive icons is presented including an identification icon 710. For this example, simply by interacting with the identification icon 710 the underlying process (as described in regard to routine 600 of FIG. 6), generates an information request for the content, submits the request to the content aggregation service 110, and receives the results (as described in routine 500 of FIG. 5). Turning to FIG. 7C, after having received the results from the content aggregation service 110, a results display window 712 is presenting showing information regarding the content/image 702. Illustratively, the results display window includes an entity card 714 describing the subject matter of the image 702 as well as several links 716-720 for displaying addition attributes and/or aspects of the image.

In regard to the entity card 714 and according to aspects of the disclosed subject matter, the content aggregation service 110 may be configured to additionally identify the subject matter of a content item with another service, such as a search engine or other service that maintains an entity graph and/or data store regarding a plurality of entities. The content aggregation service 110 may cooperate with this additional service it identify entities among the content information stored in the aggregated content store 230. When information regarding an item of content is requested, and when the content aggregation service 110 is aware that the item of content is a known entity, the content aggregation service 110 may obtain information from that service when responding to a user request. Thus, according to various embodiments of the disclosed subject matter, the entity card 714 may be drawn from an external service (such as a search engine, etc.) to the content aggregation service.

As suggested above, in addition to specific attributes/aspects of the item of content, such as attribute/value pairs represented by links 716-720, links regarding related information attributes may also include attributes regarding intended use or a suggested next step for a user. For example, when the item of content is related to a recipe, the attribute/value pairs may include information for generating a shopping list, or instructions on preparing the recipe. Similarly, if the item of content relates to a physical location, the related information may include and “attribute” for providing a map/directions to the location. Further still, if the subject matter of the item of content relates to an item of commerce, the related information may include one or more locations in which the item may be purchased and/or identify a best price for the item. In each of these instances, the computer user is advantageous presented with related information without changing the current execution content on the user's computing device.

While the example of FIGS. 7A-7C are made in regard to an image, it should be appreciated that this example is illustrative of the disclosed subject matter and should not be construed as limiting upon the disclosed subject matter. Moreover, while much of the discussion has been made in regard to content that is non-textual content, the disclosed subject matter may be implemented to identify textual content as well. Of course, in regard to other types of non-textual content, there are many advantages of the disclosed subject matter. For example, if a user is viewing a movie (audio and video) on device that includes a suitably configured, executing process for identifying content, at some point the user may wish to know what music is playing during a particular scene. Without the disclosed subject matter, the user would have to play the movie and reply another device to capture the sound. From there, the user would theoretically present the sound to a service for identification. Instead of involving multiple processes and devices, on a suitably configured computing device the user could invoke the process to identify the content. On some computing devices the user may use a touch based interface to make the query (such as illustrated in FIGS. 7A-7C.) In other alternative and/or complimentary embodiments a user may invoke the process via an audio trigger, such as speaking “Identify the background music.” Advantageously, without involving other devices, execution contexts and the like, the process may be invoked to identify the content and, in response, receive one or more items of information (typically a plurality of attribute/value pairs) regarding the content. Visual cues and/or gestures may similarly invoke the process of identifying content. Common user interface devices may also invoke the process.

Turning now to FIG. 8, FIG. 8 is a block diagram illustrating exemplary components of a computing device 800 suitable for implementing aspects of the disclosed subject matter, particularly in regard to a process executing on a computing device for identifying content. Illustratively and without limitation, suitable computing devices include desktop computers, laptop computers, tablet computers, smart phones, the so-called phablet devices (a hybrid of a tablet and smart phone), mini- and mainframe computers, game and entertainment consoles, computer-equipped appliances (such as televisions, video players, and the like), etc.

The exemplary computing device 800 includes one or more processors (or processing units), such as processor 802 and a memory 804, interconnected by way of a system bus 810. The memory 804 typically (but not always) comprises both volatile memory 806 and non-volatile memory 808, as discussed above. Further still, exemplary computing device 800 includes a network communication component 812 for interconnecting the computing device with the content aggregation service 110 over a computer network, such as network 108. The network communication component 812, sometimes referred to as a network interface card or NIC, communicates over the network 108 using one or more communication protocols via a wired connection, a wireless connection, or both. As will be readily appreciated by those skilled in the art, a network communication component, such as network communication component 812, is typically comprised of hardware and/or firmware components (and may also include or comprise software components) that transmit and receive digital and/or analog signals over a transmission medium (i.e., the network 108.)

Also included in the exemplary computing device 800 is a user I/O subsystem 814 by which the computer user can interact with the computing device. The user I/O subsystem 814 may include display devices, speakers, microphones, input devices (touch-sensitive surfaces, pointing devices, keyboard, and the like), haptic response mechanisms, and the like by which the computer user may interact with the computing device. An operating system 816 operating on the computing device provides services to one or more applications 818 that execute on the computing device. Information may be stored in a content store 822, including information regarding the identification of an item of content.

The exemplary computing device 800 also includes a content identification component 820. In execution on the computing device, the content identification component 820 provides the process by which content is identified, as described above in regard to routine 600 of FIG. 6. Typically, content identification component 820 is implemented as an executable component, such as an app/application, for execution by the processor 802. As mentioned, according to aspects of the disclosed subject matter, the content identification component 820, in execution, may be implemented as an operating system-level process such that it can be accessed by all executing applications and/or processes, it may be accessed in a consistent manner from any execution content, and may execute in such a manner as to not cause the current execution context to be changed.

Regarding the various components of the exemplary computing device 800, as well as the exemplary content aggregation service 100, those skilled in the art will appreciate that many of these components may be implemented as executable software modules stored in the memory of the computing device, as hardware modules (including SoCs—system on a chip), or a combination of the two. Moreover, many of the various components may be implemented as an independent, cooperative process or device, operating in conjunction with or on one or more computer systems and or computing devices. It should be further appreciated, of course, that the various components described above in regard to the exemplary computing device 800 or the content aggregation service 110 should be viewed as logical components for carrying out the various described functions. As those skilled in the art will readily appreciate, logical components and/or subsystems may or may not correspond directly, in a one-to-one manner, to actual, discrete components. In an actual embodiment, the various components of each computer system may be combined together or broke up across multiple actual components and/or implemented as cooperative processes on a computer network.

While various novel aspects of the disclosed subject matter have been described, it should be appreciated that these aspects are exemplary and should not be construed as limiting. Variations and alterations to the various aspects may be made without departing from the scope of the disclosed subject matter.

What is claimed:

1. A user computing device configured to provide access to content attributes, the computing device comprising a processor and a memory, wherein the processor executes instructions stored in the memory as part of, or in conjunction with, additional components to provide efficient access to content attributes, the additional components comprising:
a network communication component by which the user computing device communicates over a network with other services including a content aggregation service;
one or more applications suitable for execution on the computing device; and
a content identification component configured to execute as a process on the computing device, wherein in execution on the computing device the content identification component monitors for an indication to obtain related information regarding an item of content and, upon receiving the indication:
formulates a request for additional information regarding the item of content;
submits the request to a content aggregation service;
obtains related information regarding the item of content from the content aggregation service, the related information comprising a plurality of attribute/value pairs regarding the item of content;
presents the related information via the computing device;
wherein the content identification component performs the operations of monitoring, receiving, formulating, submitting, obtaining and presenting without changing the execution context of the computing device.

2. The computing device of claim 1, wherein a first application of the one or more applications is configured with a user actionable control that, when activated, provides the indication to the content identification component to obtain additional information regarding an item of content presented on the computing device by the first application.

3. The computing device of claim 2, wherein the first application is a network browser application.

4. The computing device of claim 1, wherein content identification component operates as an operating system-level process providing a consistent access to additional information regarding an item of content to each of the one or more applications in execution on the computing device.

5. The computing device of claim 1, wherein the subject matter of the item of content is unknown to a user of the computing device.

6. The computing device of claim 1, wherein the content identification component formulates the request for additional information regarding the item of content to comprise information identifying the item of content to the content aggregation service.

7. The computing device of claim 6, wherein the content identification component formulates the request for additional information regarding the item of content to further comprise contextual information regarding the item of content and preferences corresponding to the user of the computing device.

8. The computing device of claim 1, wherein the attribute/value pairs of the related information regarding the item of content obtained from the content aggregation service comprise distribution information of the item of content on the network.

9. The computing device of claim 1, wherein the attribute/value pairs of the related information regarding the item of content obtained from the content aggregation service comprise information identifying a location of a highest quality version of the item of content on the network.

10. The computing device of claim 1, wherein the attribute/value pairs of the related information regarding the item of content obtained from the content aggregation service comprise information identifying a location of a best description of the item of content available on the network.

11. A content aggregation service implemented on a computing device for providing information relating to an item of content, the computing device comprising a processor and a memory, wherein the processor executes instructions stored in the memory as part of or in conjunction with additional components of the aggregation content service to provide information relating to an item of content, the additional components comprising:
an information request API that communicates over a network communication component to receive a request for additional information regarding an item of content from a user computer over a network;
an information identification component that is executed by the information request API upon receipt of a request for additional information regarding an item of content, wherein the information identification component identifies the subject matter of the item of content in the received request according to information of content items stored in an aggregated content store and extracts related information to the item of content, the related information comprising a plurality of attribute/value pairs from the aggregated content store of the identified subject matter, and returns the related information to the request computer device.

12. The content aggregation service of claim 11 further comprising an information presentation component that configures the related information for presentation to a user on the requesting computer device.

13. The content aggregation service of claim 11, wherein the plurality of attribute/value pairs comprises a distribution information of the item of content on the network.

14. The content aggregation service of claim 11, wherein the plurality of attribute/value pairs comprises information regarding the location of a best quality version of the item of content available on the network.

15. The content aggregation service of claim 11, wherein the plurality of attribute/value pairs comprises information regarding the location of a best description of the item of content available on the network.

16. The content aggregation service of claim 11, wherein the plurality of attribute/value pairs comprises information regarding the location of a best caption of the item of content available on the network.

17. The content aggregation service of claim 11, wherein the related information further comprises additional related information regarding the subject matter of the item of content obtained from a third-party search service over the network.

18. A computer-implemented method for efficiently obtaining and surfacing information relating to an unknown item of content, the method comprising:
monitoring for an indication to obtain related information regarding an item of content presented to a user upon a computing device and, upon receiving the indication:
automatically formulating a request for additional information regarding the item of content;
submitting the request to a content aggregation service;
obtaining related information regarding the item of content from the content aggregation service, the related information comprising a plurality of attribute/value pairs regarding the item of content; and
presenting the related information via the computing device;
wherein the steps of monitoring, receiving, formulating, submitting, obtaining and presenting are conducted without changing the execution context on the computing device.

19. The computer-implemented method of claim 18, wherein the method is implemented as an operating system level service equally accessible to any one of the one or more applications or processes executing on the computing device.

20. The computer-implemented method of claim 18, further comprising prioritize the related information such that those items of related information identified to be most important to the content and the user are displayed before those that are identified to be less important to the user.
